(19) United States
(12) Patent Application Publication
(10) Pub. No.: US 2008/0145080 A1
(43) Pub. Date: Jun. 19, 2008

(54) Inter-Page Belt Impedance Measurement

(76) Inventor: William Paul Cook, Lexington, KY (US)

Correspondence Address: John J. McArdle, Jr.;Lexmark International, Inc., Intellectual Property Department, 740 West New Circle Road, Lexington, KY, 40550, US

(21) Appl. No.: 11/610,518

(22) Filed: Dec. 14, 2006

(51) Int. Cl. G03G 15/16

(52) U.S. Cl. 399/66

(57) ABSTRACT

An electrophotographic image forming device may use a feedback loop to track impedance characteristics of a feedback loop comprising an interface between a first component and a second component disposed and adapted to transfer a toner image therebetween. A controller may execute a search algorithm between printed pages to track the impedance characteristic and selectively adjust a transfer voltage used to transfer the toner image between the first and second component. The search algorithm may be a shortened version of a transfer servo algorithm that is used to identify the impedance characteristic. The shortened transfer servo algorithm is configured to complete in an inter-page gap or abort if the inter-page gap is too short. By tracking the impedance characteristics of the transfer interface, capacitive effects may be accounted for.

### BACKGROUND

Certain image forming devices use an electrophotographic imaging process to develop toner images on a media sheet. The electrophotographic process uses electrostatic voltage differentials to promote the transfer of toner from component to component. For example, a voltage vector may exist between a developer roll and a latent image on a photoconductive element. This voltage vector helps promote the transfer of toner from the developer roll to the latent image in a process that is sometimes called “developing the image.” A separate voltage vector may exist between the photoconductive element and a transfer member to promote the transfer of a developed image onto a substrate., in each instance, the toner transfer occurs in part because the toner itself is charged and is attracted to surfaces having an opposite charge or a lower potential.

The effective transfer of toner within an image forming device is usually dependent on many variables, including environmental conditions such as temperature and humidity. For example, in some systems there is an inverse relationship between humidity and transfer member resistance. Some image forming devices use dedicated temperature and humidity sensors to detect environmental conditions. Other image forming devices measure the voltage-current characteristics of a test signal propagated through components within the device. For example, some image forming devices transmit a signal through the interface between a transfer member and a photoconductive member. The resistance and capacitance characteristics over this interface change in relation to environmental conditions. Thus, the measured resistance/capacitance characteristics may be mapped in memory to environmental values or to actual operating parameters. Accordingly, device operating parameters, such as the transfer voltage or fuser temperature may be set in response to the detected resistance/capacitance values.

Unfortunately, the mapped resistance/capacitance values may not account for component deterioration that occurs with wear and use. Over time, the resistive and/or capacitive characteristics of a component may change. For example, the capacitance or resistance of a photoconductive layer or a transport belt may increase with wear, thereby increasing charge buildup the transfer nip over extended print jobs. Thus, unless impedance changes,are accounted for, the device may produce degraded images.

### SUMMARY

Embodiments of the present invention are directed to devices and methods to account for variations in transfer interface impedance characteristics. For example capacitance levels of a transport belt or other component may change with age. Accordingly, an electrophotographic image forming device may use a feedback loop to track the impedance characteristics of a feedback loop comprising a transfer interface. A controller may execute a search algorithm between printed pages to track the impedance characteristic and selectively adjust a transfer voltage used to transfer the tonier image at the transfer interface. The search algorithm may be a shortened version of a transfer servo algorithm that is used to identity the impedance characteristic. The shortened transfer servo algorithm is configured to complete within an inter-page gap or abort if the inter-page gap is too short. The shortened transfer servo algorithm may be performed between all printed pages or occasionally between printed pages to track gradual changes in the impedance characteristics.

### BRIEF DESCRIPTION OF THE DRAWINGS

FIG. 1 is a schematic view of an image forming device according to one embodiment;

FIG. 2 is a cross-sectional view of an image forming unit and associated power supply and transfer feedback circuit according to one embodiment;

FIG. 3 is a graphical depiction of a coarse impedance characteristic detection algorithm according to one embodiment;

FIG. 4 is a graphical depiction of a fine impedance characteristic detection algorithm according to one embodiment;

FIG. 5 is a timing diagram illustrating a representative inter-page gap for one embodiment of an image forming unit;

FIG. 6 is a flow diagram illustrating representative processing steps for executing a periodic impedance characteristic detection algorithm according to one embodiment;

FIG. 7 is a graphical depiction of a fine impedance, characteristic detection algorithm according to one embodiment; and

FIG. 8 is a graphical depiction of a component charging characteristic to illustrate suitable times for executing an impedance characteristic detection algorithm according to one embodiment.

### DETAILED DESCRIPTION

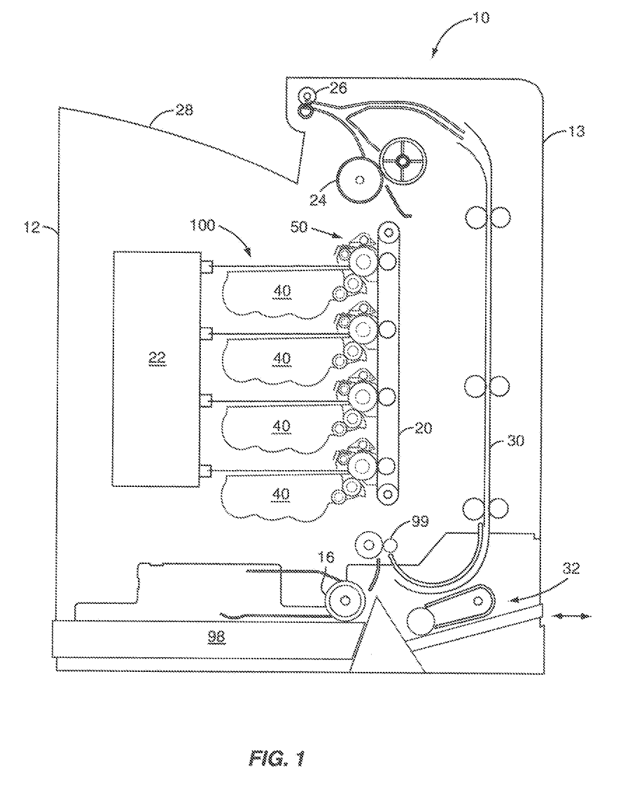

Embodiments disclosed herein are directed to devices and related methods to detect component impedance changes in an image forming device and adjust component operating levels to compensate for those detected changes. These embodiments may be applicable in a device that uses an electrophotographic imaging process such as the representative image forming device 10 shown in FIG. 1. The exemplary image forming device 10 comprises a main body 12 and a door assembly 13. A media tray 98 with a pick mechanism 16, and a multi-purpose feeder 32, are conduits for introducing media sheets into the device 10. The media tray 98 is preferably removable for refilling and located on a lower section of the device 10.

Media sheets are moved from the input and fed into a primary media path. One or more registration rollers 99 disposed along the media path aligns the print media and precisely controls its further movement along the media path. A media transport belt 20 forms a section of the media path for moving the media sheets past a plurality of image forming units 100. Color printers typically include four image forming units 100 for printing with cyan, magenta, yellow, and black toner to produce a four-color image on the media sheet.

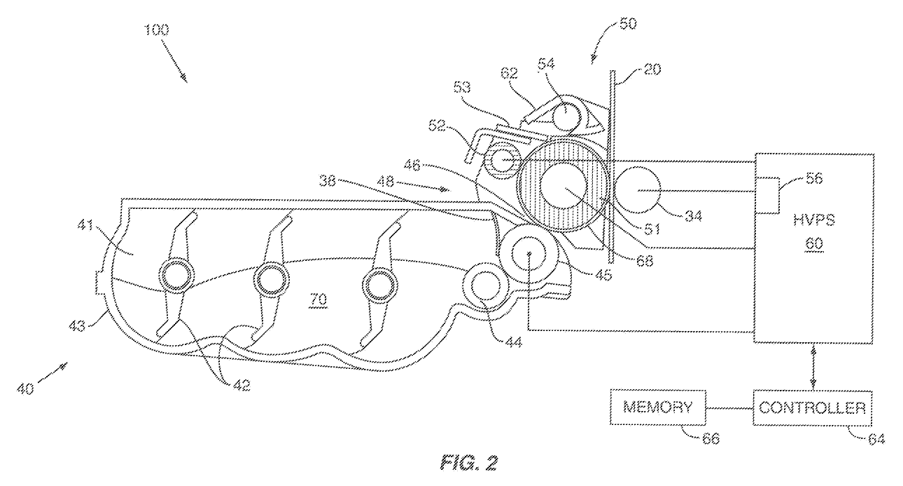

An optical scanning device 22 forms a latent image on a photoconductive member 51 (not explicitly referenced in FIG. 1 but see FIG. 2) within the image forming units 100. The latent image is developed toner supplied by a developer unit 40 and the developed image is subsequently transferred onto a media sheet that is carried past the photoconductive member 51 by a transport belt 20. The media sheet with loose, toner is then moved through a fuser 24 to fix the toner to the media sheet. Exit rollers 26 rotate in a forward direction to move the media sheet to an output tray 28, or rollers 26 rotate in a reverse direction to move the media sheet to a duplex path 30. The duplex path 30 directs the inverted media sheet back through the image formation process for forming an image on a second side of the media sheet.

As illustrated in FIGS. 1 and 2, the image forming units 100 are comprised of a developer unit 40 and a photoconductor (PC) unit 50. The developer unit 40 comprises an exterior housing 43 that forms a reservoir 41 for holding a supply of toner 70. One or more agitating members 42 are positioned within the reservoir 41 for agitating and moving the toner 70 towards a toner adding roll 44 and the developer member 45. The developer unit 40 further comprises a doctor element 38 that controls the toner 70 layer formed on the developer member 45. In one embodiment, a cantilevered, flexible doctor blade as shown in FIG. 2 may be used. Other types of doctor elements 38, such as spring-loaded, ingot style doctor elements may be used. The developer unit 40 and PC unit 50 are structured so the developer member 45 is accessible for contact with the photoconductive, member 51 at a nip 46. Consequently, the developer member 45 is positioned to develop latent images formed on the photoconductive member 51.

The exemplary PC unit 50 comprises the photoconductive member 51, a charge roller 52, a cleaner blade 53, and a waste toner auger 54 all disposed within a housing 62 that is separate from the developer unit housing 43. In one embodiment the photoconductive member 51 is an aluminum hollow-core drum with a photoconductive coating 68 comprising one or more layers of light-sensitive organic, photoconductive materials. The photoconductive, member 51 is mounted protruding from the PC unit 50 to contact the developer member 45 at nip 46. Charge roller 52 is electrified to a predetermined bias by a high voltage power supply (HVPS) 60 that is adjusted or turned on and off by a controller 64. The charge roller 52 applies an electrical charge to the photoconductive coating 68. During image creation, selected portions of the photoconductive coating 68 are exposed to optical energy, such as laser light, through aperture 48. Exposing areas of the photoconductive coating 68 in this manner creates a discharged latent image on the photoconductive member 51. That is, the latent image is discharged to a lower charge level than areas of the photoconductive 68 that are not illuminated.

The developer member 45 (and hence the toner 70 thereon) is charged by the HVPS 60 to a level failing between the bias level of charge roller 52 and the discharged latent image. In one embodiment, the developer member 45 is comprised of a resilient (e.g., foam or rubber) roller disposed around a conductive axial shaft. Other compliant and rigid roller-type developer members 45 as are, known in the aft may be used. Charged toner 70 is carried by the developer member 45 to the latent image formed on the photoconductive coating 68. As a result of the imposed bias differences, the toner 70 is attracted to the latent image and repelled from the remaining, higher charged portions of the photoconductive coating 68. At this point in the image creation process, the latent image is said to be developed.

The developed image is subsequently transferred to a media sheet being carried past the photoconductive member 51 by media transport belt 20. In the exemplary embodiment, a transfer roller 34 is disposed behind the transport belt 20 in a position to impart a contact pressure at the transfer nip. In addition, the transfer roller 34 is advantageously charged, typically to a polarity that is opposite the charged toner 70 and charged photoconductive member 51 to promote the transfer of the developed image to the media sheet.

The cleaner blade 53 contacts the outer surface of the photoconductive coating 68 to remove toner 70 that remains on the photoconductive member 51 following transfer of the developed image to a media sheet. The residual toner 70 is moved to a waste toner auger 54. The auger 54 moves the waste toner 70 out of the photoconductor unit 50 and towards a waste toner container (not shown), which ay be disposed of once full.

In one embodiment, the charge roller 52, the photoconductive member 51, the developer member 45, the doctor element 38 and the toner adding roll 44 are all negatively biased. The transfer roller 34 may be positively biased to promote transfer of negatively charged toner 70 particles to a media sheet. Those skilled in the art will comprehend that an image forming unit 100 may implement polarities opposite from these.

Periodically, such as between print jobs or at the start of a print job the HVPS 60, under the control of controller 64, implements a transfer servo routine to determine a transfer servo voltage (“TSV”) that varies in relation to changing operating conditions. The, printer controller 64 may adjust operating parameters (e.g., bias voltage applied to the transfer roller 34 or the fuser 24 shown in FIG. 1) based on the determined TSV to compensate for changes in operating conditions, including temperature and humidity.

In one embodiment, the transfer feedback voltage that produces a predetermined current through the transfer roller 34 is determined. In one embodiment, the transfer feedback current that produces a predetermined voltage through the transfer roller 34 is determined. In the illustrated embodiment, the HVPS 60 includes a sensing circuit 56 adapted to sense the voltage transmitted to the transfer roller 34 that produces a target current of 8 μA. This threshold circuit 56 produces a state change (i.e., low to high transition, otherwise referred to as a positive feedback) in a binary output signal that is sensed by the controller 64 when the transfer current equals or exceeds the target current of 8 μA. If the transfer current remains below the target current, the output of the sensing circuit 56 remains low.

In the exemplary configuration shown and described, the applied current travels through various components, including the transfer roller 34, the media transport belt 20, the photoconductive member 51 and ultimately to ground. Some of the applied current may also travel to ground via the cleaner blade 53, charge roller 52, and/or developer member 45. The voltage that produces the target current is referred to as the TSV. The value of the TSV, is transmitted to or otherwise determined by the controller 64. In one embodiment, operating parameters are mapped in memory 66 to different values of the TSV. The controller 64 reads the operating parameter for a measured TSV and, in turn, sets appropriate operating parameters for subsequent printing. FIG. 1 shows that there are four image forming units 100 if, the representative image forming device. Accordingly, the process of determining the TSV may be performed for each transfer location in the image forming device 10. In one embodiment, the process is performed simultaneously at each image forming unit 100. Alternatively, the process may be performed sequentially at each image forming unit 100.

In addition to environmental influences, component age and usage may also affect the transfer feedback voltage used to set the instantaneous operating parameters. For example, the impedance of the transport belt 20 may increase with age. Thus, an aging transport belt 20 may accumulate a surface charge that reduces transfer efficiency and lead to print quality defects. If the impedance of the transport belt is relatively then charge build-up at one of the four transfer stations may dissipate before the next transfer station. However, at higher impedance values, some of the charge on the transport belt 20 may remain and affect the other transfer locations. Ultimately, the impedance may increase to the point where the charge on the transport belt 20 remains longer than a full belt revolution. As a result, the TSV values measured at the beginning of a print job may change due to the increasing charge on the transport belt 20.

The HVPS 60 is a digitally controlled voltage supply. As a result, the HVPS 60 is capable of generating a finite plurality (e.g., 256, 512, or other power of 2) of preset voltage levels that may be used it determining the TSV. It is inefficient to determine the TSV by simply stepping the TSV up or down one voltage level at a time until the target current of 8 μA is achieved. This approach may take many iterations and the time required to complete the routine is unpredictable.

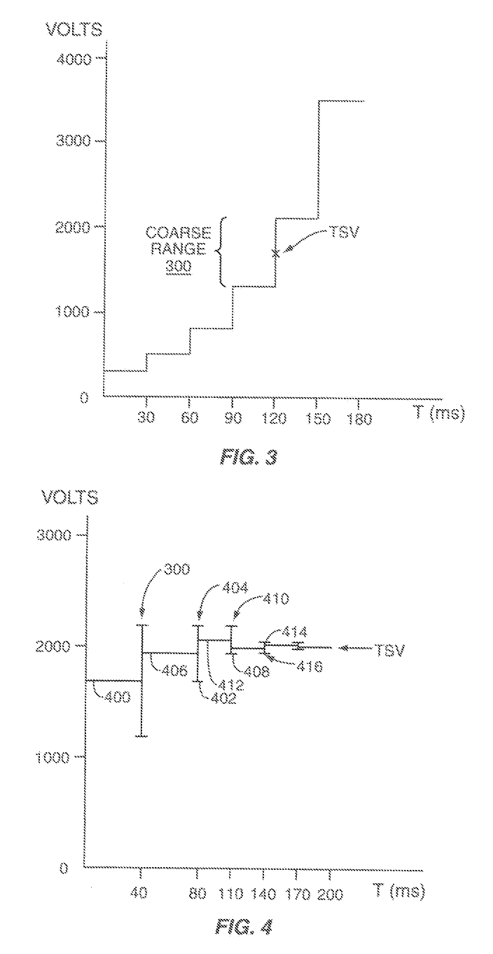

A more efficient approach to determining the transfer feedback voltage comprises two stages. In a first stage illustrated in FIG. 3, the voltage initially set to a minimum value that is virtually guaranteed to fall below the actual TSV. If this resulting current falls below the target current as expected, the routine continues to search at different transfer voltages for the final TSV. After each test voltage is applied, the resulting current is measured. The voltage is increased with varying step sizes over the possible range of TSV levels until a positive feedback is found. This first stage determines a coarse range within which the final TSV lies. In a second stage described below, the possible range of TSV values is sequentially halved, with the upper or lower range limit changing after each measurement to narrow in on the TSV.

FIG. 3 is a graphical representation of the varying voltage step sizes that are used in the first stage of the transfer servo routine. The step size is limited in that the transfer current should always be less than the charge roller 52 current. The charger roll 52 and the transfer roller 34 are oppositely biased. Thus, the transfer current should be maintained below that of the charge roller so that the charge polarity, on the surface 68 of the photoconductive drum 51 remains the same. In one embodiment, a critical limit for the transfer current is set at approximately 13 μA.

As FIG. 3 shows, the voltage step size increases as the transfer voltage increases during the first stage of the routine. This is possible because the lowest hypothesized transfer impedance (i.e., the composite impedance of the transfer roller, transport belt, PC drum, etc . . . ) increases with each measurement. Consequently, the voltage step can increase without moving too far past the TSV, thereby avoiding a current that exceeds the critical limit. Each step size is chosen to be as large as possible while not creating too large a current, given the possible range of hypothesized transfer impedances at that point. With this algorithm, the entire voltage range of the HVPS 60 is covered with 6 measurements. If a fixed voltage step size, were used, the same range would require 17 measurements.

The second stage algorithm is shown in FIG. 3. In each successive measurement of this stage, the TSV range is divided in half. The routine keeps the upper half or the lower half of the previous range depending on the feedback from the previous sample. At each step of the second stage, a sample is taken with a test voltage equal to the halfway point between the upper and lower range limits. For example, the first seed sample 400 of the second stage is chosen as approximately the midpoint of the coarse range determined from the first stage. In the illustrated example, this value is about 1700V. This first sample voltage, 400 fails to produce a positive, feedback because it is below the voltage that produces the critical current. Accordingly, this first sample voltage 400 becomes the lower limit 402 of the next, range 404. If the sample produced a positive feedback, the sample voltage becomes the upper limit of the, next range 404. The upper or lower range limit is changed after each measurement. In practice, the boundaries of the voltage ranges may be increased slightly to account for tolerances in the system.

The second stage algorithm continues in a similar manner at range 404 with sample 406 failing to produce a positive feedback. Again, this is because the sample 406 is below the actual TSV. Again, the sample 406 becomes the lower limit 408 for the next smaller range 410. The midway point in range 410 provides the next sample 412, which is above the actual TSV. Thus, this sample 412 produces positive feedback and becomes the upper limit 414 of the next smaller range 416. Ultimately, the second stage algorithm proceeds towards the final TSV in approximately six steps. For a coarse range of about 1000V, the final TSV is determined by subsequent having steps to produce a final value that is within about 16 volts of the actual TSV, which should be appropriate to set the desired component operating parameters.

The voltage step sizes decrease at each step. Initially, the relatively large voltage step sizes require an increased settling time for the voltage to stabilize before testing for a positive feedback. In the illustrated example, about 40 ms is provided for each of the first and second steps. The remaining four samples require, less time (e.g., about 30 ms in the illustrated example). Ultimately, the routine, narrows the range to a value that is selected as the TSV. For the present example, the TSV that produces a target current of 8 μA is about 1500V. This voltage, or the digital representation of this voltage, is transmitted to the controller, which adjusts the system operating parameters accordingly. For the illustrated example, the combined first and second stages are able, to produce a TSV in less than about 500 ms. The second binary stage narrows in on the TSV in approximately 200 ms.

Alternative voltage measurements may be conceived that accomplish the substantially similar TSV selection depending on the available inter-page time. For instance, a second set of coarse samples with smaller, steps than the first coarse search may be used, followed by a linear set of single steps. The search should improve the TSV selection consistently between pages.

Notably, all of the voltage ranges in the second stage algorithm are within a fairly tight range (e,g., <500V) Consequently, the voltage swings do not adversely affect the charge on the photoconductive drum 51. The voltages during the transfer servo routine are also less than the available recharge current from the charge roll. Thus, an even surface potential is achieved in each pass of the photoconductive drum 51 through the charge roller 52. If this were not the case, additional passes would be required to produce the even charge on the photoconductive drum 51 and print defects may occur in the interim. Alternatively, the inter-page gap would have to be extended to allow multiple passes of the photoconductive drum 51 past the charge roller 52, thus reducing throughput.

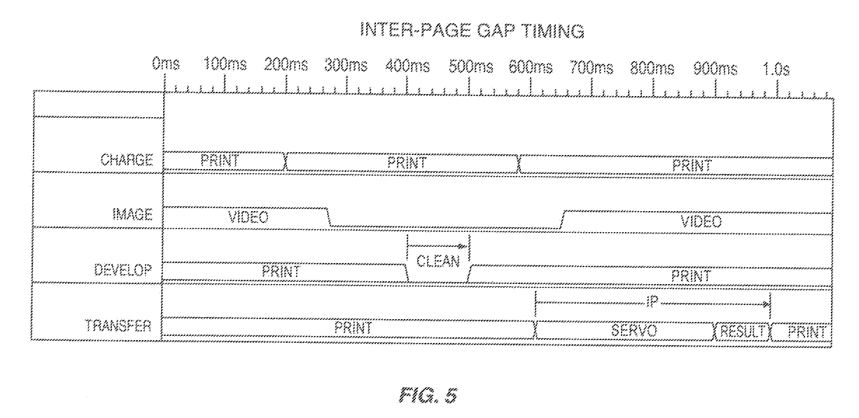

FIG. 5 shows a representative timing diagram for the exemplary image forming unit 100. The voltage applied to the charge roller 52 is left substantially constant for the duration of a print cycle. The voltage applied to the developer roller 45 to charge the toner 70 is briefly reduced or turned off during a cleaning cycle during periods in which the laser 22 is not firing to create a latent image. The inter-page (IP) region for the transfer roller 34 is offset from the IMAGE and DEVELOP time lines due to the relative positioning of the components. The transfer voltage is normally set to n IP voltage between pages to avoid exposing the transport belt 20 and photoconductive drum 51 to the relatively high voltages required to transfer toner from the photoconductive drum 51 onto a media sheet. The duration of the in range is determined in part by the desired throughput of the image forming device 10. In the illustrated example, this IP duration is in excess of 300 ms but less than the 500 ms required for a full (first stage plus second stage) transfer servo routine. However, the IP duration is sufficiently long to implement the binary second stage of the transfer servo routine.

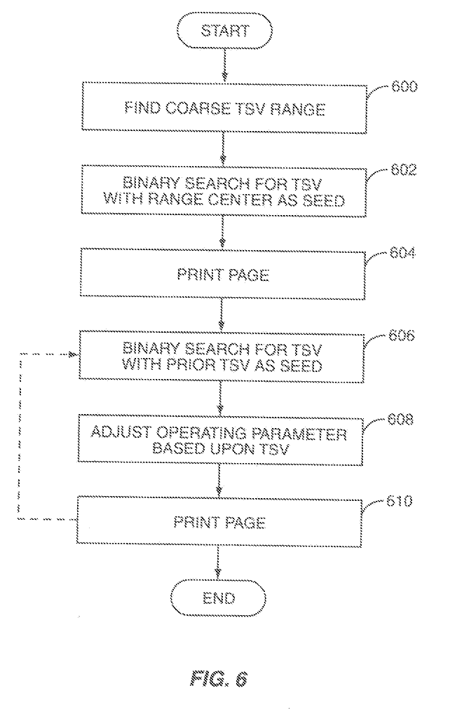

Accordingly, the process steps shown in FIG. 6 are provided to perform an initial transfer servo routine and a periodic shortened transfer servo routine to accurately track the impedance of components in the transfer nip. Initially, such as at the start of a print job, the first stage of the transfer servo routine begins at step 600 to identify a coarse TSV range as in FIG. 3, Next, at step 602, the second stage of the transfer servo algorithm begins a binary search for the TSV as in FIG. 4. This binary search step 602 begins with the center of the coarse range identified in step 600 as the initial voltage sample (seed) for binary search. Once the TSV is identified, the image forming device 10 may proceed to print a desired media sheet page at step 604. The image forming device 10 produces the printed pages at a desired throughput (e.g., 20, 24, or greater pages per minute) and will produce the next printed page 610 with a limited IP duration therebetween. Within this IP duration, a shortened transfer servo routine is completed. In the illustrated embodiment, the second stage of the transfer servo routine begins a binary search for the TSV in step 606. This binary search step 606 begins with the most recently obtained TSV as the initial voltage sample (seed) for binary search. Once the TSV is identified, the controller 64 may identify an associated operating parameter stored in memory 66 and adjust the operating parameter as needed. This adjustment may include adjusting the transfer voltage applied during image formation or the transfer voltage applied during the IP range. The dashed line in FIG. 6 further suggests that the shortened search for the TSV may be implemented during each IP region. In this manner, the IP servo may measure increased TSV values after each printed page and track component impedance and set the transfer voltage for desirable results on each page.

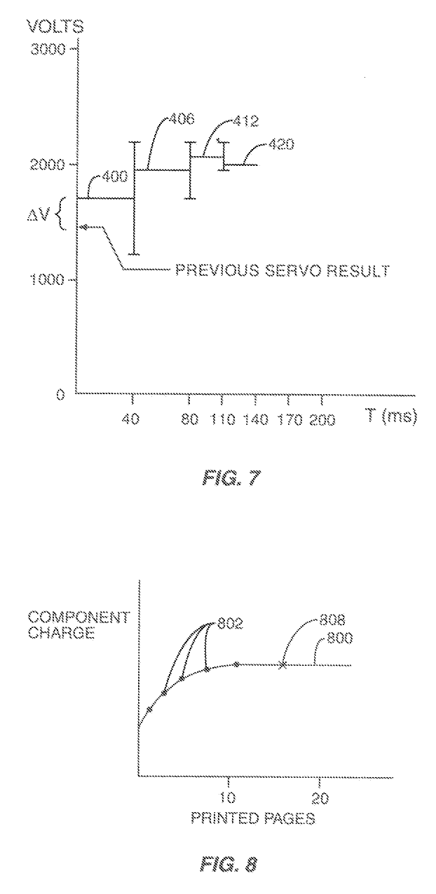

The entire shortened IP transfer servo routine may be implemented between printed pages. In one embodiment where the IF duration is about 300 ms, the binary search for the TSV should be completed in about 200 ms, leaving about 100 ms to identify and implement the results, of the servo routine. In certain cases, the IP gap between printed pages may be abnormally low, due to pick variations. For the IP gap may be too short to complete the IP transfer servo routine. Accordingly, FIG. 7 illustrates an embodiment of the shortened binary search that is performed during the IP gap. As identified above, the seed value for the initial voltage sample may be provided by the most recent servo result. In one embodiment, the seed value is raised by some nominal value above the prior result giver, the propensity for the TSV to increase over time. For example, the initial voltage sample in the binary search may be about 100V higher than the previous servo result.

In the illustrated example, the IP gap is too small to complete the binary search. Instead, the search is terminated after four voltage samples. Accordingly, a decision is made to use the optimal last known sample as the TSV. For instance, the last known sample 420 may be selected as the TSV. In one embodiment, the last known increasing sample 412 may be selected as the TSV. Any one of the samples 400, 406, 412, or 420 may be selected as the optimum TSV.

As desorbed above, the shortened IP transfer servo routine may be executed during each inter-page gap. This implementation provides a simple solution that is not dependent upon counters or conditions. This does not suggest that the shortened IP transfer servo routine may be implemented on a sparse basis, such as after a certain period of time or after a certain period of print jobs. However, it should be understood that if the shortened IP transfer servo routine is not executed during each inter-page gap, the routine should implemented at certain appropriate times. FIG. 8 depicts a representative component charge curve in relation to the number of pages printed from a discharged state. For example, the capacitive nature of the transport belt 20 is such that the charge rises or decays according to an RC time constant. In certain systems, this time constant may be on the order of about one minute. Accordingly, it may be appropriate, in one embodiment, to perform the shortened IP transfer servo routine periodically for a first predetermined number of pages until the capacitive component has completely charged as indicated by flattened curve region 800. The dotted samples 802 in FIG. 8 identify this type of periodic samples of the TSV. In one embodiment, the shortened IP transfer servo routine is performed during each inter-page gap for a first predetermined number, of pages. In one embodiment, these samples 802 may be taken for the first 10 or so pages. In one embodiment, samples 802 may be taken after several pages (e.g., 2-3 pages) for a first predetermined number of pages. In another embodiment, the RC time constant may be taken into consideration and a single TSV sample 808 may be taken after the component charge is expected to settle. This single sample 808 may be tracked over time to analyze the long term progress of the component impedance.

Those skilled in the art should also appreciate that the control circuitry associated with controller 64 shown in FIG. 2 for implementing the present invention may comprise hardware, software, or any combination thereof. For example, circuitous, for initiating, performing, and adjusting the transfer feedback voltage may be a separate hardware circuit, or may be included as part of other processing hardware. More advantageously, however, the processing circuitry in these devices is at least partially implemented via stored computer program instructions for execution by one or more computer devices, such as microprocessors, Digital Signal Processors (DSPs), ASICs or other digital processing circuit s included in the controller 64. The stored program instructions may be stored in electrical, magnetic, or optical memory devices, such ROM and RAM modules, flash memory, hard disk drives, magnetic disc drives, optical disc drives and other storage media known in the art.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise,

The present invention may be carried out in other specific ways than those herein set forth without departing from the scope and essential characteristics of the invention. For instance, the component impedance changes discussed above have been described in terms of a transport belt. It should be understood that similar impedance changes may be detectable for a transfer belt, which is a belt to which toner images are directly transferred. The long-term impedance characteristics of these and other types of image forming components may be tracked with the shortened 12 transfer servo routine. The present embodiments are, therefore, to be considered in all respects as illustrative and not restrictive, and all changes coming within the meaning and equivalency range of the appended claims are intended to be embraced therein.

What is claimed is:

1. An electrophotographic image forming device comprising:
an image forming unit comprising a first component and a second component disposed and adapted to transfer a toner image therebetween;
a sensing unit operative to detect an impedance characteristic of a feedback loop comprising an interface between the first component and the second component; and
a controller operative to execute a search algorithm during each inter-page gap to track the impedance characteristic and selectively adjust a transfer voltage used to transfer the toner image between the first and second component.

2. The device of claim 1 wherein the detected impedance characteristic of the feedback loop comprises a detected current produced by passing a known voltage across one of the first component or the second component.

3. The device of claim 2 wherein the controller is operative to pass a first known voltage during a first step of the search algorithm to determine if the detected current exceeds a predetermined threshold, the controller operative to pass a second known voltage during a second step of the search algorithm to determine if the detected current exceeds the predetermined threshold.

4. The device of claim 3 wherein the first known voltage is determined from a prior execution of the search algorithm.

5. The device of claim 3 wherein a difference between the first known voltage and second known voltage produces a corresponding charge on a photoconductive surface that is correctable by a single pass of the photoconductive surface by a charge roller.

6. The device of claim 1 wherein the search algorithm is a binary search algorithm.

7. The device of claim 1 wherein the controller is further operative to abort the search algorithm if a time gap between printed pages is insufficient to complete the search algorithm.

8. The device of claim 1 wherein the controller narrows by one half a possible range for the impedance characteristic in subsequent steps of the search algorithm.

9. A method of adjusting a transfer voltage in an image forming device, the method comprising:
printing a plurality of printed pages;
executing a search algorithm between each of the plurality of printed pages, the search algorithm determining an impedance characteristic of a feedback loop comprising an interface between a photoconductive member and a transfer member, the search algorithm comprising subsequent steps of reducing a possible range for the impedance characteristic by one half based upon whether a detected current produced by applying a known voltage in the feedback loop exceeds a predetermined threshold; and
adjusting a transfer voltage used to transfer a toner image at the interface between the photoconductive member and the transfer member.

10. The method of claim 9 wherein the interface between the photoconductive member and the transfer member includes a transport belt.

11. The method of claim 9 wherein the search algorithm further comprises applying a first known voltage during a first step of the search algorithm to determine if the detected current exceeds a predetermined threshold and applying a second known voltage during a second step of the search algorithm to determine if the detected current exceeds the predetermined threshold.

12. The method of claim 11 further comprising determining the first known voltage from a prior execution of the search algorithm.

13. The method of claim 12 further comprising adding a predetermined voltage offset to a voltage determined from the prior execution of the search algorithm.

14. The method of claim 11 wherein the step of applying the second known voltage further comprises producing a corresponding charge on the photoconductive member that is correctable by a single pass of the photoconductive member by a charge roller.

15. The method of claim 9 wherein the search algorithm is a binary search algorithm.

16. The method of claim 9 further comprising aborting the search algorithm if an inter-page time gap is insufficient to complete the search algorithm.

17. The method of claim 16 further comprising assigning the impedance characteristic to an intermediate estimate of the impedance characteristic.

18. A method of adjusting a transfer bias in an image forming device the method comprising:
executing a full transfer servo routine that comprises identifying a coarse range for an impedance characteristic of a feedback loop comprising an interface between a photoconductive member and a transfer member;
in an inter-page gap between printed pages of a multi-page print job, executing a shortened transfer servo routine comprising a fine search algorithm for determining the impedance characteristic, the fine search algorithm comprising subsequent steps of reducing a possible range for the impedance characteristic by one half based upon whether a detected current produced by applying a known voltage in the feedback loop exceeds a predetermined threshold; and
adjusting a transfer voltage used to transfer a toner image at the interface between the photoconductive member and the transfer member.

19. The method of claim 18 wherein the shortened transfer servo routine uses an initial estimate of the impedance characteristic from the full transfer servo routine.

20. The method of claim 18 wherein the shortened transfer servo routine uses an initial estimate of the impedance characteristic from a prior execution of the shortened transfer servo routine.

21. The method of claim 18 further comprising executing the shortened fine search algorithm between ail printed pages produced by the image forming device.

22. The method of claim 18 further comprising aborting the shortened search algorithm if the inter-page gap is insufficient to complete the search algorithm.

23. The method of claim 22 further comprising assigning the impedance characteristic to an intermediate estimate of the impedance characteristic.

24. The method of claim 18 further comprising executing the shortened fine search algorithm occasionally between printed pages produced by the image forming device to track gradual changes in the impedance characteristic.
